(19) United States
(12) Patent Application Publication
(10) Pub. No.: US 2010/0067403 A1
(43) Pub. Date: Mar. 18, 2010

(54) DIRECT DEVICE TO DEVICE CONFIGURATION TRANSFER

(75) Inventors: Richard Mark Clayton, Manorville, NY (US); Robert E. Beach, Los Altos, CA (US); Tom Bianculli, Manorville, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/212,179

(22) Filed: Sep. 17, 2008

(51) Int. Cl. H04L 12/28

(52) U.S. Cl. 370/254

(57) ABSTRACT

Systems and methodologies for direct device-to-device transfer of configuration information, such as network information, are provided herein. As described herein, network keys and other information can be transferred from a device that stores and/or utilizes the information to one or more devices to be initialized on a corresponding network. Network information can be communicated using audio tones, light pulses, and/or other similar signals to facilitate transfer of network information using one or more hardware components present at devices involved in the transfer for other purposes and without requiring specialized hardware. Systems and methodologies disclosed herein enable new devices to a network to be programmed by an already-programmed device, thereby reducing the need for off-site network initialization in cases where a small number of devices are to be added to an existing population. In addition, secure transfer of network information without exposing the information in a transferable format is facilitated.

### TECHNICAL FIELD

The subject disclosure relates generally to computer networking, and more particularly to techniques for configuring a device to operate in a network.

### BACKGROUND

Network-capable devices, such as mobile devices and other suitable communication and/or computing devices, often require network keys and other network-related information in order to connect to and function in a network. Traditionally, initialization of a device on a network is performed with the aid of a deployment software program and/or a similar computer-based technique. However, such techniques are often significantly complex, and as a result these techniques generally require a person trained in the operation of the network to be carried out.

Further, an off-site integration specialist is often required for network initialization due to the confidential nature of the information used to initialize a device onto a network and the fact that many organizations lack on-site technology support. While off-site initialization processes can be sufficient for bulk programming of many network devices, such processes can be prohibitively costly and inefficient for operations involving small numbers of devices, such as the addition of a small number of devices to supplement an existing population of devices. Accordingly, there is a need for network initialization techniques that mitigate at least the above shortcomings.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Systems and methodologies are provided herein that facilitate improved initialization for devices to be associated with a network. In particular, network configuration information can be transferred from a device with knowledge of the network configuration information to one or more devices to be initialized on a corresponding network. In accordance with one aspect described herein, communication can be conducted directly from one network-capable device to another in order to transfer network parameters and/or other associated network information between the devices.

In accordance with one aspect, network information can be communicated using audio tones, light pulses, and/or similar signals in order to allow devices to transfer network information to one another using one or more hardware components present on the respective devices for other purposes and without requiring specialized hardware for the transfer of network information. As described herein, a device connected to a network and/or otherwise provided with configuration information for the network can identify pre-stored network configuration information and/or clone its own network configuration information. Based on this information, the device can convey a series of audio tones, light pulses, or the like to enable one or more other devices within communication range of the device to connect to the network. By transferring network information in this manner, new devices to a network can be programmed by an already-programmed device, thereby reducing the need for off-site network initialization in cases where a small number of devices are to be added to an existing population. Further, by utilizing audio tones, light pulses, and the like to communicate network information, a transfer of network information can be securely conducted without exposing the information in a transferable format.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system for transferring configuration information in accordance with various aspects.

FIG. 2 is a block diagram of a system that facilitates transfer of network parameters between devices in accordance with various aspects.

FIG. 3 is a block diagram of a system for transferring network configuration information using an audio tone sequence in accordance with various aspects.

FIG. 4 is a block diagram of a system for transferring network configuration information using a light pulse sequence in accordance with various aspects.

FIG. 5 illustrates an example tone configuration that can be implemented for transfer of information in accordance with various aspects.

FIGS. 6-7 illustrate an example tone combination scheme that can be implemented to communicate information in accordance with various aspects.

FIG. 8 is a flowchart of a method for conveying initialization information.

FIG. 9 is a flowchart of a method of communicating a set of network configuration information as a series of audio tones.

FIG. 10 is a flowchart of a method of identifying configuration parameters from a received communication sequence.

FIG. 11 is a block diagram of a computing system in which various aspects described herein can function.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g. hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

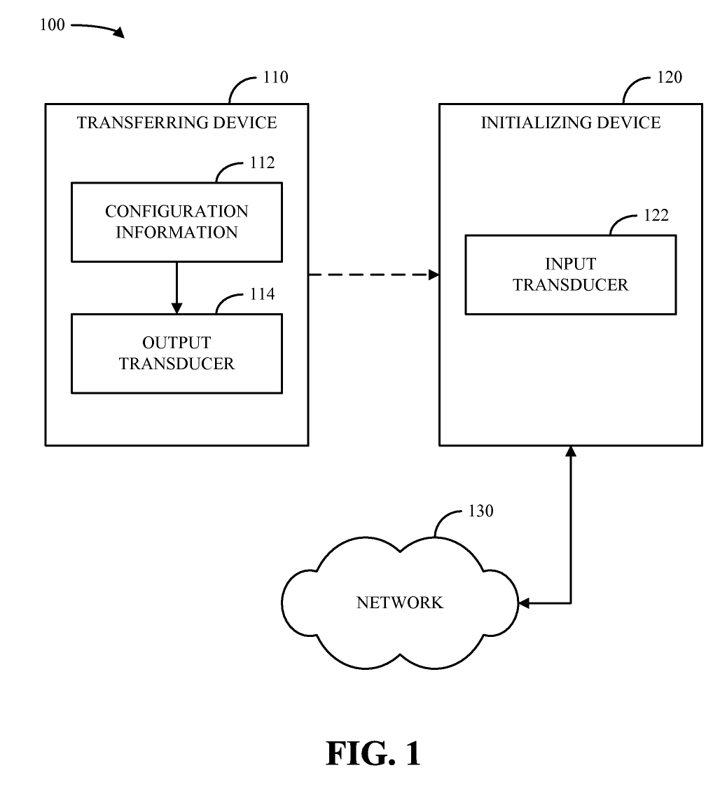

Referring now to the drawings, FIG. 1 illustrates a block diagram of a system 100 for transferring configuration information 112, such as network deployment information, in accordance with various aspects described herein. In one example, system 100 can include one or more transferring devices 110 having information relating to a network 130 associated therewith and one or more receiving devices 120 that can receive information relating to the network 130 and/or other suitable information from one or more transferring devices 110 in order to connect to the network 130. It can be appreciated that a transferring device 110 and/or an initializing device 120 can be fixed and/or mobile devices and can additionally be any suitable type of device operable to transfer information and/or function in a networked environment. It can additionally be appreciated that transferring device(s) 110 and initializing device(s) 120 in system 100 can be the same type of device or different types of devices. Further, while only an initializing device 120 is illustrated as connected to network 130 in FIG. 1, it can be appreciated that a transferring device 110 and/or other devices can also be connected to network 130. However, it can further be appreciated that a transferring device 110 need not be connected to network 130 or even capable of connecting to network 130 in order to facilitate a transfer of information to an initializing device as described herein.

In accordance with one aspect, network 130 can have various data associated therewith, such as network keys and other suitable information, which are utilized by a device in connecting to the network 130. Thus, for example, before an initializing device 120 is added to network 130, the initializing device 120 may be required to be provided with these associated data and/or other similar information. Traditionally, computer-based deployment programs have been utilized to initialize a device on a network. However, due to the complex nature of these deployment programs, off-site integration specialists are often required to carry out initialization of a device on a network. As a result, it can be prohibitively costly and inefficient to add a small number of initializing devices 120 into an existing network environment 130. This can be the case when, for example, a device in an existing network environment malfunctions or is otherwise removed from operation in a network 130 and a new device 120 is associated with the network 130 to replace the removed device. In such a case, due to the complexity and cost associated with off-site integration, it is generally not desirable to employ an off-site integration specialist for the addition of a single new device.

Accordingly, system 100 can enable an initializing device 120 to obtain information required for associating with a network 130 from another device 110 having knowledge of such information, thereby allowing network initialization to be conducted automatically on a device-by-device basis. In this manner, it can be appreciated that system 100 enables a “rumor” model for network initialization, such that a new device 120 to be connected to a network 130 can learn connection information for the network 130 from another device 110 that has been provided with the required connection information. As a result, network device initialization can be conducted without the complex and intensive deployment process traditionally associated with such initialization.

In one example, network device initialization can be conducted by system 100 as follows. Prior to initialization of a new device 120 on a network 130, one or more transferring devices 110 in system 100 can be provided with configuration information 112. The configuration information 112 can include network keys and/or other network security information, information relating to synchronization, power control, or the like, and/or any other suitable information that can be utilized by a device upon device initialization and/or initial association with the network 130. In another example, configuration information 112 can be predefined and stored at the transferring device 110. Additionally and/or alternatively, in the case of a transferring device 110 that is connected to network 130, the configuration information 112 can be cloned from the configuration information used by the transferring device 110 itself for connecting to the network 130.

In accordance with one aspect, once configuration information 112 has been identified, it can be converted into a communication sequence to be provided to one or more initializing devices 120. In one example, such a sequence can be constructed as a series of binary symbols respectively representing single bits of the configuration information 112. Alternatively, various forms of modulation can be utilized to represent multiple bits of information per symbol. Various techniques that can be utilized for sequence formation are discussed in further detail infra. In one example, the configuration information 112 can itself be a sequence such that conversion of the information 112 to a sequence is not necessary prior to its communication.

In accordance with another aspect, upon identifying a sequence corresponding to the configuration information 112, the sequence can be communicated by the transferring device 110 using an output transducer 114. In one example, further configuration information and/or other information can be communicated by the transferring device 110 using the output transducer 114 in addition to the configuration information 112. It can be appreciated that the output transducer 114 can be any suitable device for converting the configuration information 112 and/or its corresponding sequence into a series of emissions and/or other communications from the transferring device 110. For example, the output transducer 114 can be a speaker, a light (e.g., infrared or visible) emitter, or the like. In one example, a communication by the transferring device 110 can be a broadcast communication and/or a directed communication to one or more identified initializing devices 120.

In accordance with an additional aspect, upon communication of a sequence by the output transducer 114 at the transferring device 110 corresponding to the configuration information 112, the sequence can be received by an input transducer 122 at an initializing device 120. Upon reception of a sequence at the initializing device 120, the sequence can be decoded to recover the configuration information 112, which can subsequently be utilized to configure the device 120 and/or connect to network 130. In one example, the input transducer 122 can be any suitable device for obtaining digital information from a communication provided by an output transducer 114 at a transferring device 110. By way of non-limiting example, the input transducer 122 can be a microphone, an optical sensor, a motion detector, or the like.

It is to be appreciated that an output transducer 114 at a transferring device 110 and/or an input transducer 122 at an initializing device 120 as used in the transfer of configuration information 112 can be elements of the respective devices 110 and/or 120 that are provided for other functionality of the devices 110 and/or 120, thereby eliminating a need for specialized hardware to transfer configuration information 112 between the devices 110 and 120. For example, the transducers 114 and/or 122 can be a speaker and microphone provided for voice communication, a light emitter and sensor provided for motion sensing, and/or any other similar transducer combination.

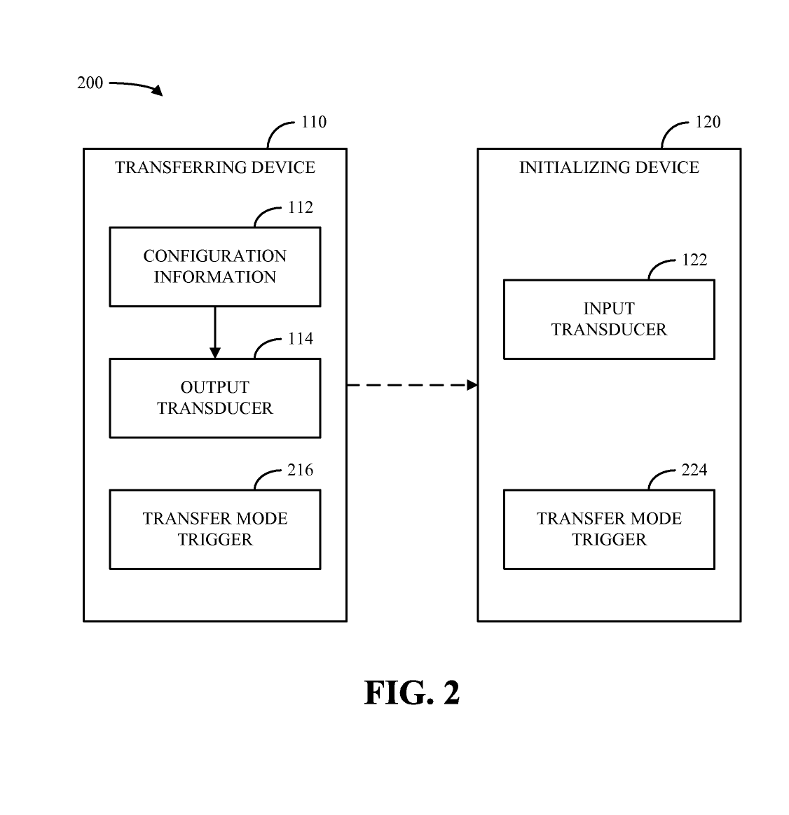

Turning to FIG. 2, a system 200 that facilitates transfer of network parameters between devices is illustrated. As illustrated by FIG. 2, system 200 can include a transferring device 110, which can provide encryption keys and/or other suitable configuration information 112 to an initializing device 120. A transfer of configuration information 112 can be conducted using an output transducer 114 at the transferring device 110 and an input transducer 122 at the initializing device 120 in a similar manner to that described above with respect to system 100.

In accordance with one aspect, a transferring device 110 and/or an initializing device 120 in system 200 can additionally include respective transfer mode triggers 216 and/or 224, which can be utilized to trigger the transfer of configuration information 112 from a transferring device 110 to an initializing device 120. In one example, at a time at which an initializing device 120 is to be added to a network, a transfer mode trigger 216 at the transferring device 110 can be engaged to begin the communication of configuration information 112. A transfer mode trigger 216 and/or 224 can be, for example, a physical trigger, such as a switch or button coupled to an associated device, and/or a non-physical trigger such as a selection on a menu or user interface associated with the device or a predefined combination or sequence of inputs (e.g., a passcode or another appropriate input sequence). Additionally and/or alternatively, a transfer mode trigger 216 and/or 224 can include a combination of components, such as a menu selection followed by entry of a passcode or the like.

In one example, upon engagement of transfer mode trigger 216 at a transferring device 110, the transferring device 110 can communicate configuration information 112 via an output transducer 114. In accordance with one aspect, the transferring device 110 can communicate configuration information 112 one or more times upon triggering. For example, the transferring device 110 can communicate configuration information 112 a predetermined number of times for each engagement of the transfer mode trigger 216, or the transferring device 110 can communicate configuration information 112 continuously until the transfer mode trigger 216 is engaged again and/or another predefined event occurs to terminate communication.

Upon communication of configuration information 112, an initializing device 120 can receive the information 112 and utilize it to connect to an associated network. In one example, the initializing device 120 can be configured to attempt to detect communicated configuration information 112 at all times. Alternatively, the initializing device 120 can also be equipped with a transfer mode trigger 224 such that the initializing device 120 attempts reception of configuration information 112 for a predetermined time subsequent to triggering. In one example, a time period for which the initializing device 120 attempts reception of configuration information 112 upon triggering can be fixed or variable (e.g., until successful reception of configuration information 112).

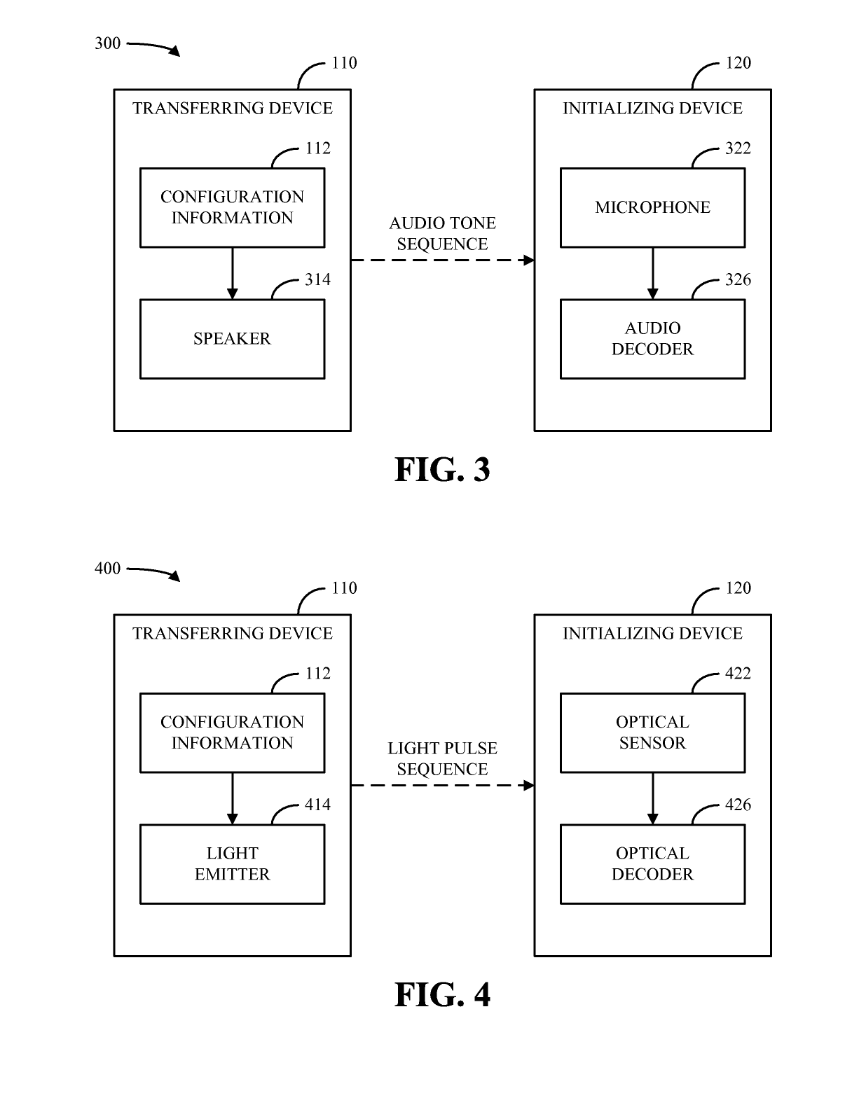

FIG. 3 is a block diagram of a system 300 for transferring configuration information 112 using an audio tone sequence in accordance with various aspects. In one example, configuration information 112 can be communicated directly from a transferring device 110 to an initializing device 120 in order to enable the initializing device 120 to connect to a network associated with the configuration information 112. In accordance with one aspect, configuration information 112 can be encoded and/or otherwise processed at the transferring device 110 to construct a communication sequence of audio tones. In one example, audio tones can be generated to be any suitable length or combination of lengths. Further, respective audio tones in a generated sequence can be constructed to respectively convey one or more bits of information. Techniques for constructing an audio tone sequence to convey one or more bits of information per tone are described in further detail infra. Upon generating a series of audio tones, the series can then be provided to a speaker 314 and/or another suitable audio output transducer at the transferring device 110.

In one example, the speaker 314 at the transferring device 110 can play the series of audio tones over the open air, where one or more initializing devices 120 can utilize a microphone 322 and/or another suitable audio input transducer to receive the audio tone sequence. Received audio tones can then be provided to an audio decoder 326, which can decode the audio tone sequence to recover the configuration information 112 therefrom.

In accordance with one aspect, a speaker 314 and/or microphone 322 can be provided at respective devices 110 and 120 in connection with other audio communication capability of the devices 110 and 120, such as voice communication, media playback, or the like. Thus, it can be appreciated that the network configuration transfer technique illustrated by system 300 can be implemented without requiring additional specialized hardware at the transferring device 110 or initializing device 120. Further, it can be appreciated that as configuration information 112 is not exposed in a transferable format during transfer illustrated by system 300, enhanced security for the configuration information 112 can be achieved during its transfer. In one example, security of the configuration information 112 can be further enhanced by encrypting the information 112 prior to its transfer. By way of example, configuration information 112 can be encoded using an encryption method known a priori to the audio decoder 326 such that the audio decoder 326 can decrypt the configuration information 112 upon receiving the corresponding audio tones

FIG. 4 illustrates a system 400 for transferring configuration information 112 using a light pulse sequence in accordance with various aspects. As FIG. 4 illustrates, configuration information 112 can be transferred from a transferring device 110 to an initializing device 120 in order to enable the initializing device 120 to connect to a network associated with the configuration information 112. In accordance with one aspect, configuration information 112 can be encoded and/or otherwise converted to a series of light pulses, which can then be provided to a light emitter 414 and/or another suitable transducer. It can be appreciated that light pulses in a constructed sequence can be any suitable uniform or non-uniform length. By way of specific, non-limiting example, light pulses in a constructed sequence can have respective lengths of 1 millisecond and/or any other suitable length. Further, it can be appreciated that the light emitter 414 can utilize a single light wavelength (e.g. infrared) or multiple wavelengths in combination. In addition, pulses in the constructed sequence can respectively represent single binary bits of information or multiple bits by, for example, varying in intensity and/or wavelength.

In one example, the light emitter 414 can emit a constructed series of light pulses, at which time one or more initializing devices 120 can utilize an optical sensor 422 and/or another suitable input transducer to receive the pulse series. Data relating to received light pulses can then be provided to an optical decoder 426, which can decode the light pulse sequence to recover the configuration information 112 therefrom.

In accordance with one aspect, a light emitter 414 and/or optical sensor 422 can be provided at respective devices 110 and/or 120 in connection with other functionality of the respective devices 110 and/or 120, such as motion capture and/or sensing or the like, to facilitate the transfer of configuration information 112 without requiring additional specialized hardware at the transferring device 110 or initializing device 120. In addition, it can be appreciated that a transfer of configuration information 112 as illustrated by system 400 can be conducted without exposing the configuration information 112 in a transferable format, thereby enhancing security in a similar manner to the transfer illustrated by system 300. In addition, it can be appreciated that security can be optionally enhanced further by applying encryption to the configuration information 112 as additionally described above with regard to system 300.

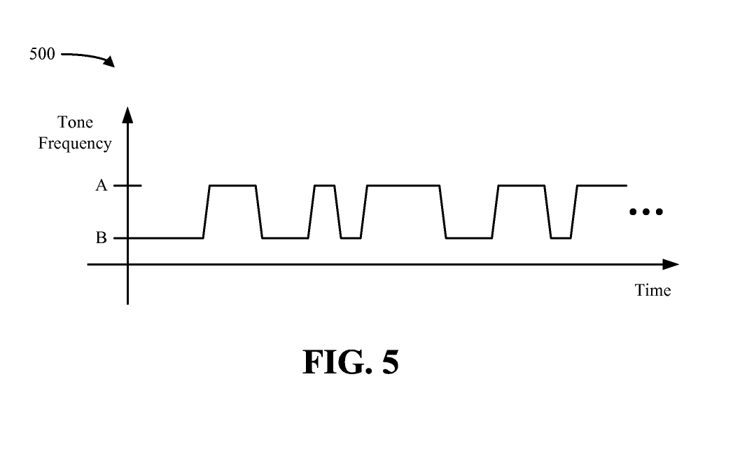

Turning now to FIG. 5, a diagram 500 is provided that illustrates an example tone configuration that can be implemented for transferring information (e.g. configuration information 112) in accordance with various aspects. As diagram 500 illustrates, a signal can be constructed for transferring network information and/or other appropriate information as a series of tones. As diagram 500 further illustrates, respective tones in a signal can be generated using one of a first frequency or a second frequency, which are respectively denoted in diagram 500 as frequencies A and B.

In one example, tones in a signal such as that represented by diagram 500 can respectively represent one bit of information based on the frequency used to generate the respective tones. Thus, for example, a tone constructed using frequency A can have a binary value of 1, while a tone constructed using frequency B can have a binary value of 0. Alternatively, more than two frequencies can be utilized to represent more than one bit of information per tone. As a specific example, a set of four possible frequencies can be used such that respective tones represent two bits of information. More generally, it can be appreciated that a signal can be constructed in a manner similar to that illustrated by diagram 500 using tones having one of a possible N frequencies, wherein each tone can be used to represent up to log₂(N) bits of information.

In another example, a signal such as that illustrated by diagram 500 can be constructed using a series of uniform-length tones and communicated at a pre-defined rate (e.g., 300-1200 symbols per second). Accordingly, the presence of consecutive tones in a communicated signal that represent the same value(s) can be determined by the length of time at which a signal remains at a given frequency.

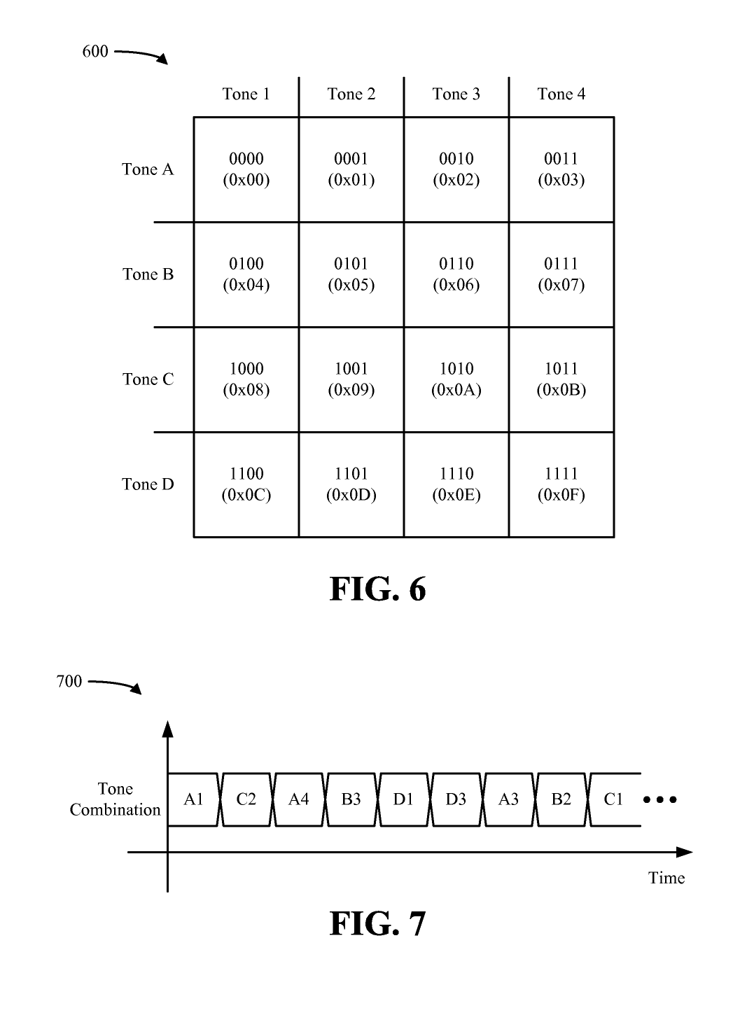

Referring to FIG. 6, a table 600 is provided that illustrates an example tone combination scheme that can be implemented to communicate information in accordance with various aspects described herein. More particularly, table 600 illustrates a Dual-Tone Multi-Frequency (DTMF) scheme that can be utilized to represent multiple bits of network information and/or other suitable information into a single combination of audio tones and/or other communicated tones. Table 600 represents a tone combination scheme that enables communication of four bits of information using a single combination of two tones. However, it should be appreciated that tone combinations can be designed to represent any number of bits in a similar manner to the scheme illustrated by table 600.

As table 600 illustrates, the possible bit group values that can be represented by a single tone combination can be arranged in a two-dimensional tabular structure having a predefined number of rows and columns. While table 600 is illustrated as a 4×4 square, it should be appreciated that table 600 can consist of any suitable number of rows and columns and that the number of rows and columns need not be equal. Upon arranging bit group values into the table, respective tones can be associated with the rows and columns of the table. By doing so, a bit group can be represented as a combination of tones corresponding to the row and column at which the set of bits is located in the table. As illustrated in table 600, row tones are denoted as tones A-D and column tones are denoted as tones 1-4. In one example, row tones can be designed to be lower in frequency than column tones, or vice versa, to increase the decoding accuracy of signals constructed using combinations of the row tones and column tones. Additionally and/or alternatively, in order to avoid decoding errors, the row and column tones can be configured such that no tone is a multiple of another tone and/or such that no tone has a frequency equal to the sum of the frequencies of two or more other tones.

Upon generating a signal representing a set of information using tone combinations as illustrated by table 600, the signal can be communicated as illustrated by diagram 700 in FIG. 7. As diagram 700 illustrates, combinations of tones can be communicated as a sequence in time having a predefined rate. As used in diagram 700, tone combinations are referred to by the letter of the row tone and the number of the column tone corresponding to a bit group as illustrated by table 600. Thus, for example, the combination A1 represents a combination of row tone A and column tone 1. In one example, as a predefined rate is used for tone combination transmission, the presence of consecutive tone combination in a communicated signal representing the same bit group can be determined by the length of time at which a signal remains at a given tone combination.

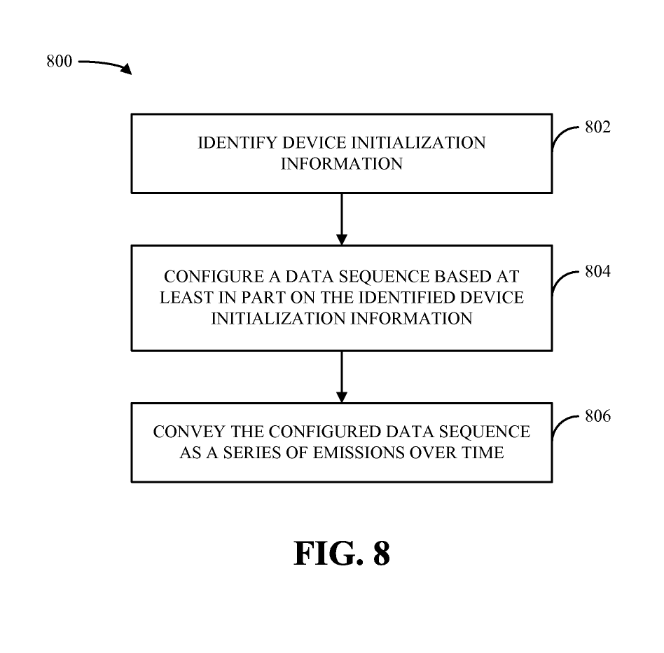

Turning to FIGS. 8-10, methodologies that may be implemented in accordance with various features presented herein are illustrated via respective series of acts. It is to be appreciated that the methodologies claimed herein are not limited by the order of acts, as some acts may occur in different orders, or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as claimed herein.

Referring to FIG. 8, a method 800 for conveying device initialization information (e.g., configuration information 112) is illustrated. At 802, device initialization is identified. At 804, a data sequence is configured (e.g., by a transferring device 110) based at least in part on the device initialization information identified at 802. At 806, the data sequence configured at 804 is conveyed (e.g., by an output transducer 114) as a series of emissions (e.g., sound, light, etc.) over time.

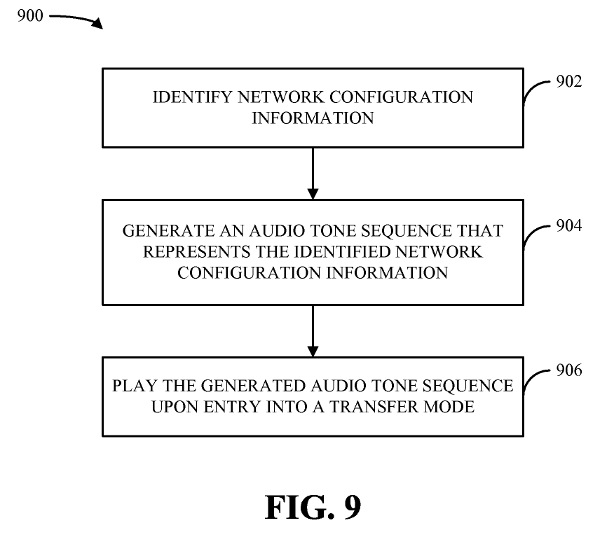

FIG. 9 illustrates a method of communicating a set of network configuration information as a series of audio tones. At 902, network configuration information is identified. At 904, an audio tone sequence (e.g., a sequence as illustrated by diagram 500 and/or diagram 700) is generated that represents the network configuration information identified at 902. At 906, the audio tone sequence generated at 904 is played (e.g., by a speaker 314) upon entry into a transfer mode (e.g., triggered by a transfer mode trigger 216).

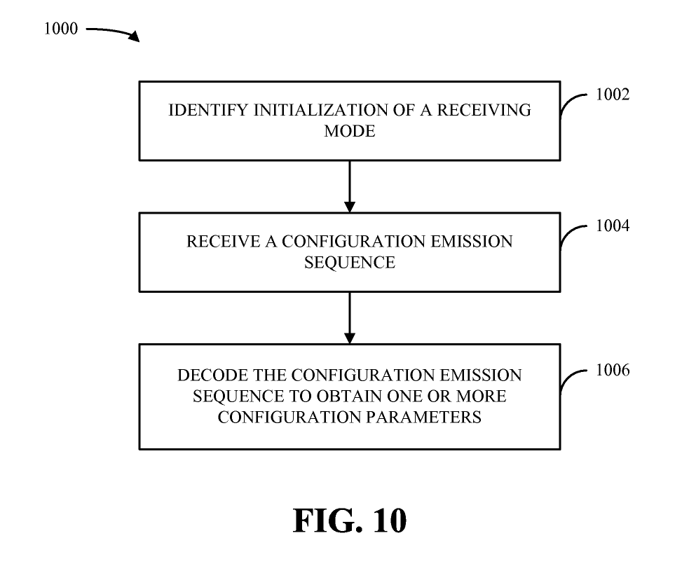

Referring now to FIG. 10, a flowchart is provided that illustrates a method 1000 of identifying configuration parameters (e.g. configuration information 112) from a received communication sequence. At 1002, initialization of a receiving mode (e.g., as triggered by a transfer mode trigger 224 at an initializing device 120) is identified. At 1004, a configuration emission sequence is received (e.g., at an input transducer 122). At 1006, the configuration emission sequence received at 1004 is decoded (e.g., by an audio decoder 326, an optical decoder 426, or the like) to obtain one or more configuration parameters.

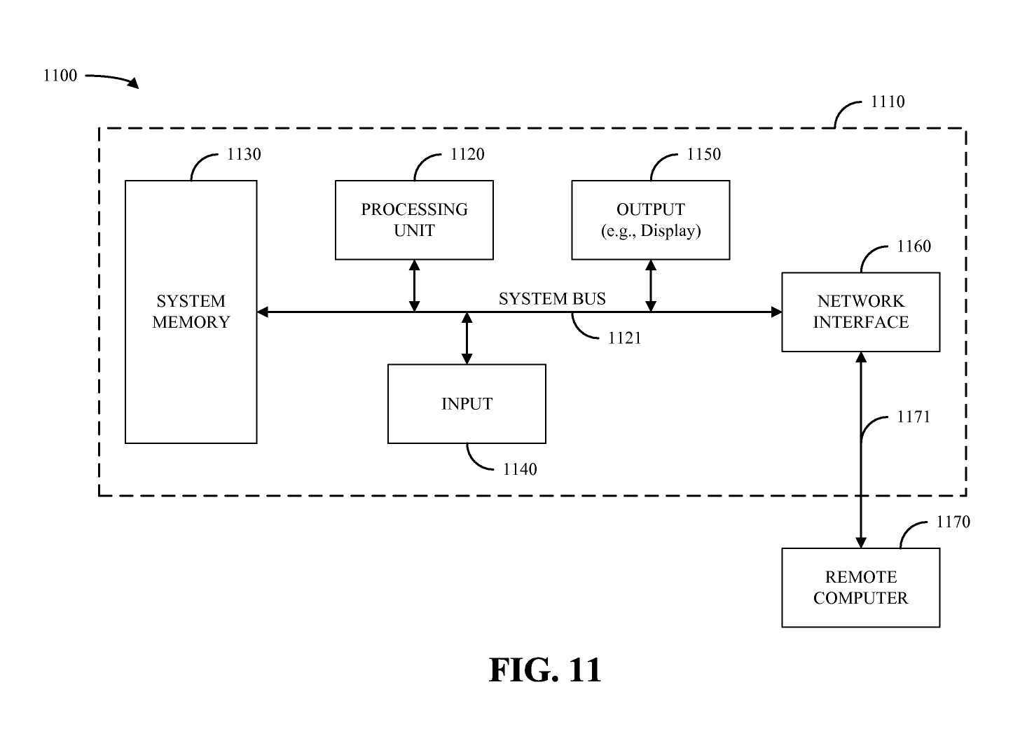

Turning to FIG. 11, an example computing system or operating environment in which various aspects described herein can be implemented is illustrated. One of ordinary skill in the art can appreciate that handheld, portable and other computing devices and computing objects of all kinds are contemplated for use in connection with the claimed subject matter, e.g. anywhere that a network can be desirably configured. Accordingly, the below general purpose computing system described below in FIG. 11 is but one example of a computing system in which the claimed subject matter can be implemented.

Although not required, the claimed subject matter can partly be implemented via an operating system, for use by a developer of services for a device or object, and/or included within application software that operates in connection with one or more components of the claimed subject matter. Software may be described in the general context of computer executable instructions, such as program modules, being executed by one or more computers, such as client workstations, servers or other devices. Those skilled in the art will appreciate that the claimed subject matter can also be practiced with other computer system configurations and protocols.

FIG. 11 thus illustrates an example of a suitable computing system environment 1100 in which the claimed subject matter can be implemented, although as made clear above, the computing system environment 1100 is only one example of a suitable computing environment for a media device and is not intended to suggest any limitation as to the scope of use or functionality of the claimed subject matter. Further, the computing environment 1100 is not intended to suggest any dependency or requirement relating to the claimed subject matter and any one or combination of components illustrated in the example operating environment 1100.

With reference to FIG. 11, an example of a computing environment 1100 for implementing various aspects described herein includes a general purpose computing device in the form of a computer 1110. Components of computer 1110 can include, but are not limited to, a processing unit 1120, a system memory 1130, and a system bus 1121 that couples various system components including the system memory to the processing unit 1120. The system bus 1121 can be any of several types of bus structures including a memory bus or memory controller, a peripheral bus, and a local bus using any of a variety of bus architectures.

Computer 1110 can include a variety of computer readable media. Computer readable media can be any available media that can be accessed by computer 1110. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110. Communication media can embody computer readable instructions, data structures, program modules or other data in a modulated data signal such as a carrier wave or other transport mechanism and can include any suitable information delivery media.

The system memory 1130 can include computer storage media in the form of volatile and/or nonvolatile memory such as read only memory (ROM) and/or random access memory (RAM). A basic input/output system (BIOS), containing the basic routines that help to transfer information between elements within computer 1110, such as during start-up, can be stored in memory 1130. Memory 1130 can also contain data and/or program modules that are immediately accessible to and/or presently being operated on by processing unit 1120. By way of non-limiting example, memory 1130 can also include an operating system, application programs, other program modules, and program data.

The computer 1110 can also include other removable/non-removable, volatile/nonvolatile computer storage media. For example, computer 1110 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 1121 through a non-removable memory interface such as an interface, and a magnetic disk drive or optical disk drive can be connected to the system bus 1121 by a removable memory interface, such as an interface.

A user can enter commands and information into the computer 1110 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 1120 through user input 1140 and associated interface(s) that are coupled to the system bus 1121, but can be connected by other interface and bus structures, such as a parallel port, game port or a universal serial bus (USB). A graphics subsystem can also be connected to the system bus 1121. In addition, a monitor or other type of display device can be connected to the system bus 1121 via an interface, such as output interface 1150, which can in turn communicate with video memory. In addition to a monitor, computers can also include other peripheral output devices, such as speakers and/or a printer, which can also be connected through output interface 11150.

The computer 1110 can operate in a networked or distributed environment using logical connections to one or more other remote computers, such as remote computer 1170, which can in turn have media capabilities different from device 1110. The remote computer 1170 can be a personal computer, a server, a router, a network PC, a peer device or other common network node, and/or any other remote media consumption or transmission device, and can include any or all of the elements described above relative to the computer 1110. The logical connections depicted in FIG. 11 include a network 1171, such as a local area network (LAN) or a wide area network (WAN), but can also include other networks/buses. Such networking environments are commonplace in homes, offices, enterprise-wide computer networks, intranets and the Internet.

When used in a LAN networking environment, the computer 1110 is connected to the LAN 1171 through a network interface or adapter. When used in a WAN networking environment, the computer 1110 can include a communications component, such as a modem, or other means for establishing communications over the WAN, such as the Internet. A communications component, such as a modem, which can be internal or external, can be connected to the system bus 1121 via the user input interface at input 1140 and/or other appropriate mechanism. In a networked environment, program modules depicted relative to the computer 1110, or portions thereof, can be stored in a remote memory storage device. It should be appreciated that the network connections shown and described are non-limiting examples and that other means of establishing a communications link between the computers can be used.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects. In this regard, it will also be recognized that the described aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for communicating configuration parameters, comprising:
a first device that identifies one or more configuration parameters and configures a communication sequence based on the identified configuration parameters; and
a transducer at the first device that communicates the configured communication sequence at least in part by emitting at least one of audio or light based on the configured communication sequence.

2. The system of claim 1, wherein the first device further comprises a transfer mode trigger that instructs communication of the configured communication sequence upon engagement thereof.

3. The system of claim 1, wherein the transducer at the first device comprises one or more audio speakers.

4. The system of claim 3, wherein the configured communication sequence comprises respective audio tones corresponding to respective groups of one or more bits in the configuration parameters based at least in part on frequencies of the respective audio tones.

5. The system of claim 3, wherein the configured communication sequence comprises respective combinations of audio tones corresponding to respective groups of one or more bits in the configuration parameters based on a Dual-Tone Multi-Frequency (DTMF) tone combination scheme.

6. The system of claim 1, wherein the transducer at the first device comprises a light emitter and the communication sequence comprises respective light pulses that correspond to respective bits of the configuration parameters.

7. The system of claim 1, further comprising a second device, the second device comprising:
a transducer that receives the communication sequence communicated by the transducer at the first device; and
a decoder that recovers the configuration parameters from the received communication sequence.

8. The system of claim 7, wherein the second device further comprises a transfer mode trigger that causes the transducer at the second device to attempt reception of a communication sequence upon engagement thereof.

9. The system of claim 7, wherein the transducer at the first device comprises one or more audio speakers that provide voice output data obtained from the second device, and the transducer at the second device comprises a microphone that facilitates communication of voice input data to the first device.

10. The system of claim 1, wherein the first device obtains the configuration parameters by cloning configuration parameters utilized by the first device.

11. The system of claim 1, wherein the configuration parameters relate to a network.

12. The system of claim 11, wherein the configuration parameters comprise network encryption keys.

13. A method of transferring configuration information, comprising:
identifying configuration information to be communicated;
configuring a data sequence based at least in part on the identified configuration information; and
conveying the configured data sequence as at least one of an audio tone sequence or a light pulse sequence.

14. The method of claim 13, wherein the conveying comprises:
detecting entry into a transfer mode; and
conveying the configured data sequence upon detecting entry into the transfer mode.

15. The method of claim 13, wherein the configuring comprises configuring a series of audio tones having frequencies that respectively correspond to groups of one or more bits in the identified configuration information.

16. The method of claim 13, wherein the configuring comprises configuring a series of combined audio tones based on a Dual-Tone Multi-Frequency (DTMF) scheme that respectively correspond to groups of one or more bits in the identified configuration information.

17. The method of claim 13, further comprising:
identifying initialization of a receiving mode;
receiving a conveyed data sequence upon identification of the receiving mode; and
decoding the received data sequence to recover the configuration information therefrom.

18. The method of claim 13, wherein the configuration information comprises network configuration information that facilitates connection to a network corresponding to the network configuration information.

19. A system that facilitates device-to-device transfer of initialization information, comprising:
means for constructing a communication sequence based at least in part on a set of initialization information; and
means for broadcasting the communication sequence as at least one of an audio emission or a light emission.

20. The system of claim 19, further comprising:
means for identifying a broadcasted communication sequence; and
means for decoding the broadcasted communication sequence to recover initialization information therefrom.
